(19) United States
(12) Patent Application Publication
(10) Pub. No.: US 2024/0383738 A1
(43) Pub. Date: Nov. 21, 2024

(54) CAN LID CUTTER

(71) Applicant: 346 Inc, Gunma (JP)

(72) Inventors: Shu KANNO, Gunma (JP); Manabu SHIMOGORI, Gunma (JP); Morihito SAIGUSA, Gunma (JP)

(21) Appl. No.: 18/786,572

(22) Filed: Jul. 29, 2024

Related U.S. Application Data
(63) Continuation of application No. PCT/JP2022/040508, filed on Oct. 28, 2022.

(30) Foreign Application Priority Data
Jan. 31, 2022 (JP) 2022-012986

(51) Int. Cl. B67B 7/46

(52) U.S. Cl. CPC B67B 7/34; B67B 2007/303

(57) ABSTRACT

A can lid cutter is a can lid cutter that cuts a lid from a can by cutting a cylindrical raised portion of the outer periphery at the upper end of the can, the can lid cutter includes: a main body having a circular recessed portion formed in a circular shape for receiving the raised portion; a blade provided in the main body to cut the raised portion; an operation portion for pressing the blade toward the raised portion in a state where the main body is mounted on the can; and a tab holder that is provided inside the circular recessed portion and holds a stay-on-tab of the can in a state where the main body is mounted on the can.

### CROSS-REFERENCE TO RELATED APPLICATIONS

The present application is a continuation application of International Application number PCT/JP2022/40508, filed on Oct. 28, 2022, which claims priority under 35 U.S.C § 119 (a) to Japanese Patent Application No.2022-012986, filed on Jan. 31, 2022. The contents of these applications are incorporated herein by reference in their entirety.

### BACKGROUND OF THE INVENTION

The present disclosure relates to a can lid cutter.

Conventionally, can lid cutters for cutting lids from cans are known. Japanese Unexamined Patent Application Publication No.11-91874 discloses an instrument equipped with a rotary blade for cutting the inner surface of the rising edge wall at the upper end of a can and a rod-shaped hook for holding the stay-on-tab of a lid that has been cut off.

Using a conventional can lid cutter requires complicated operations.

### BRIEF SUMMARY OF THE INVENTION

The object of the present disclosure is to provide a can lid cutter that enables simple operations and prevents the can lid that has been cut off from falling into the can.

A can lid cutter according to the present disclosure for solving the above-described problem is a can lid cutter that cuts a lid from a can by cutting a cylindrical raised portion of an outer periphery at an upper end of the can, the can lid cutter including: a main body having a recessed portion receiving the raised portion; a blade that is provided in the main body for cutting the raised portion; an operation portion for pressing the blade toward the raised portion in a state where the main body is mounted on the can; and a tab holder that is provided inside the recessed portion and holds a stay-on-tab of the lid in a state where the main body is mounted on the can.

### BRIEF DESCRIPTION OF THE DRAWINGS

FIG. 1 is a top perspective view of a can lid cutter according to one embodiment of the present disclosure.

FIG. 2 is a bottom perspective view of the can lid cutter.

FIG. 3 is a top planar view of the can lid cutter.

FIG. 4 is a bottom view of the can lid cutter.

FIG. 5 is a perspective view of the can lid cutter from which a top cover of a main body is removed.

FIG. 6 is a planar view of the can lid cutter from which the top cover of the main body is removed.

FIG. 7 is a side view of the can lid cutter.

FIG. 8 is a perspective view showing only an operation portion.

FIG. 9 is a perspective view showing the can lid cutter mounted on the can.

FIG. 10 shows a configuration of the can.

FIG. 11A is a perspective view of a tab holder, and FIG. 11B is a front view of the tab holder.

FIG. 12 is an enlarged perspective view showing the tab holder and its peripheral structure.

FIGS. 13A and 13B are schematic views for explaining a movement of the tab holder.

FIG. 14 is a view showing how the can lid cutter is mounted on the can.

FIG. 15 shows the can lid cutter mounted on the can.

FIG. 16 shows a variation example of the can lid cutter of the present disclosure.

FIG. 17 is a perspective view showing one example of another embodiment of the can lid cutter.

FIG. 18 is a bottom perspective view of the can lid cutter of FIG. 17.

FIG. 19 is a bottom view of the can lid cutter of FIG. 17.

FIG. 20 is a perspective view showing the can lid cutter according to one embodiment of the present disclosure mounted on the can.

FIG. 21 is a top perspective view of the can lid cutter.

FIG. 22 is a planar view of the can lid cutter.

FIG. 23 is a bottom perspective view of the can lid cutter.

FIGS. 24A and 24B are views for explaining a sliding member.

FIG. 25 is a perspective view showing the sliding member and its peripheral structure.

FIG. 26 is a top view of the can lid cutter.

FIG. 27 is a perspective view showing an adapter member that holds a raised portion of the can.

FIG. 28 is a view showing the adapter member provided in the main body.

FIG. 29 is a view for explaining a further variation example of the can lid cutter.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

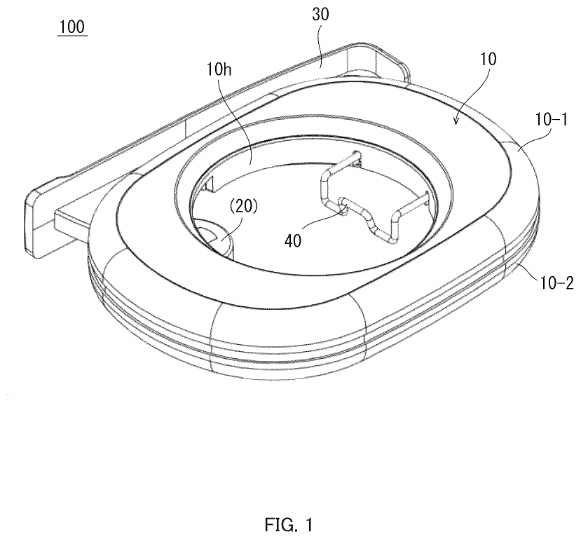

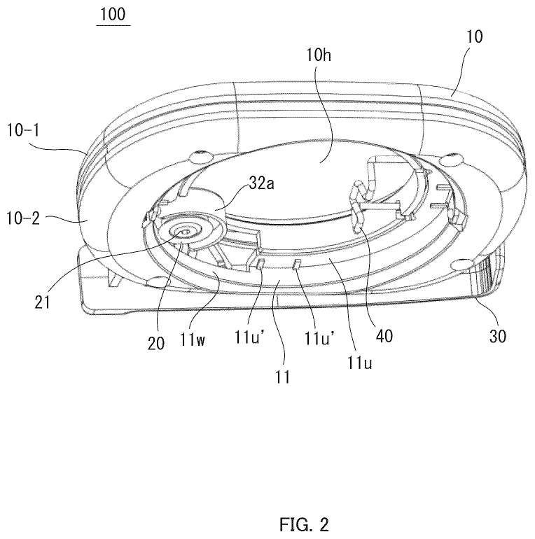

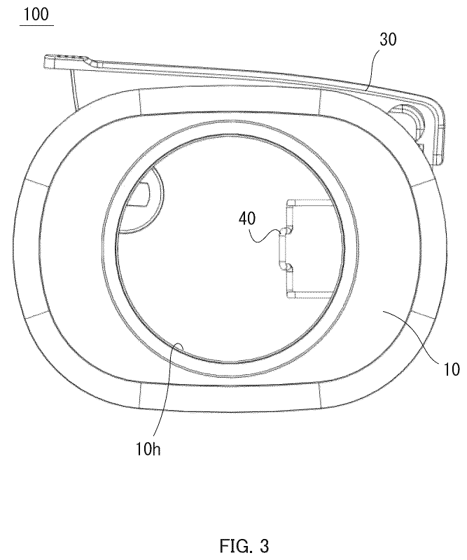

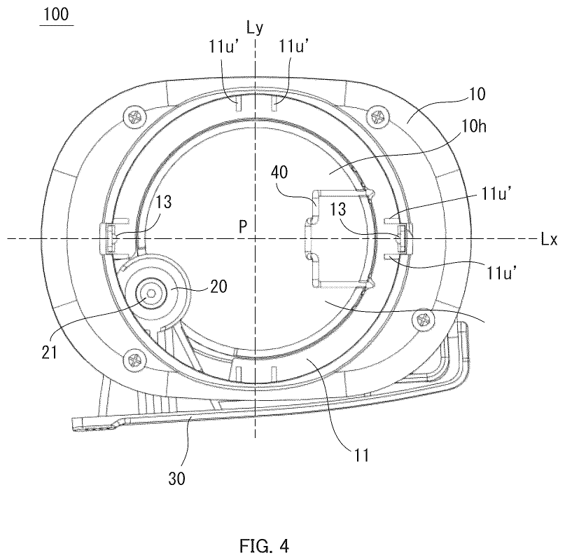

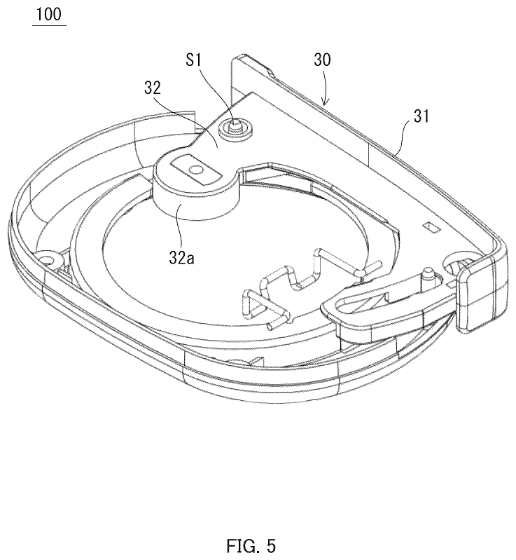

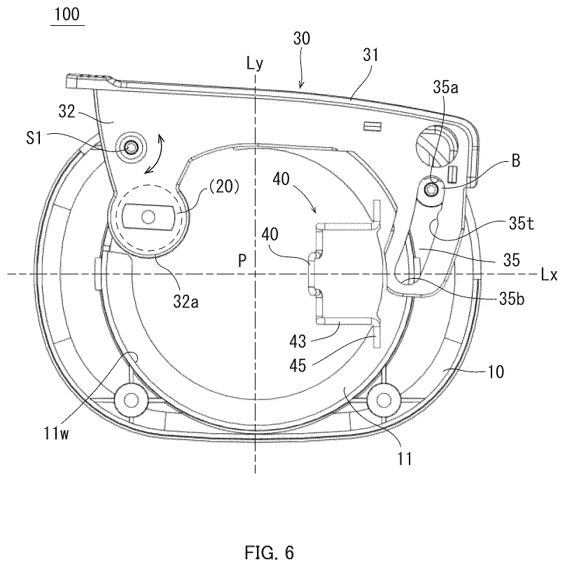

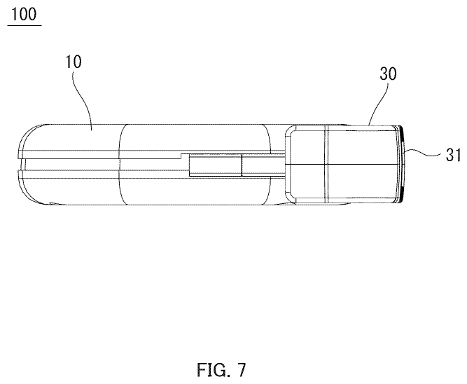

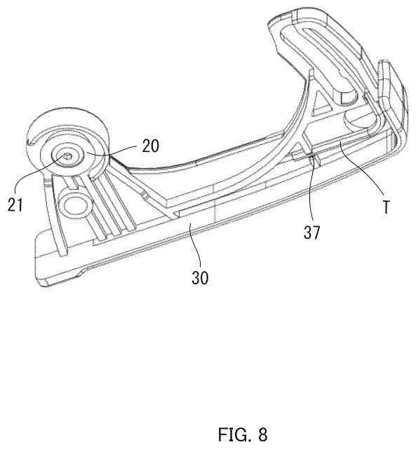

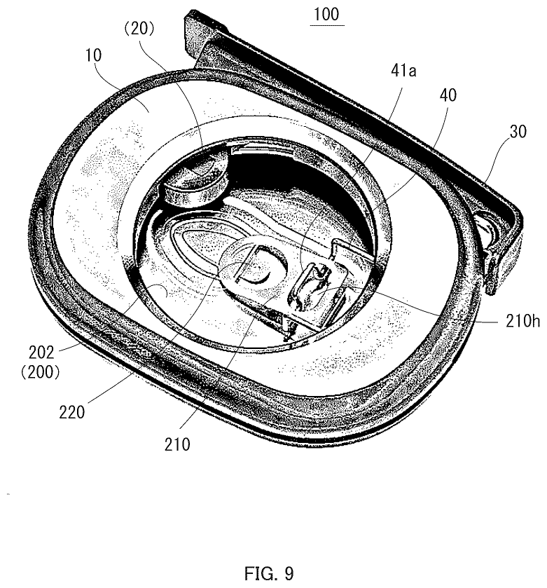

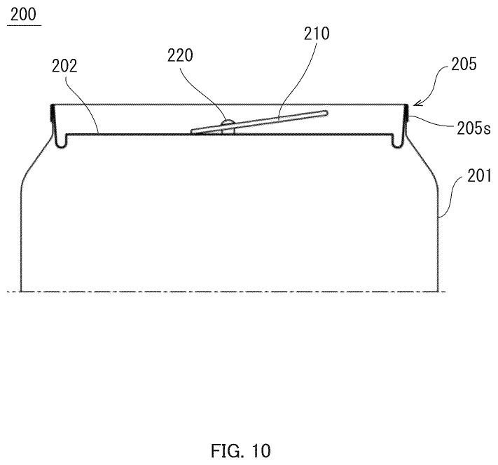

Hereinafter, embodiments of the present disclosure will be described with reference to the drawings. FIG. 1 is a top perspective view of a can lid cutter 100 according to one embodiment of the present disclosure. FIG. 2 is a bottom perspective view of the can lid cutter 100. FIG. 3 is a top planar view of the can lid cutter 100. FIG. 4 is a bottom view of the can lid cutter 100. FIG. 5 is a perspective view of the can lid cutter 100 from which a top cover 10-1 of a main body 10 is removed. FIG. 6 is a planar view of the can lid cutter 100 from which the top cover 10-1 of the main body 10 is removed. FIG. 7 is a side view of the can lid cutter 100. FIG. 8 is a perspective view showing only an operation portion 30. FIG. 9 is a perspective view showing the can lid cutter 100 mounted on a can 200. FIG. 10 shows a configuration of the can 200.

In the following, terms indicating directions such as “up,” “down,” “right,” and “left” are used in accordance with the orientation of an object depicted in the drawings, but these terms are not intended to limit the present disclosure. The upward and downward direction corresponds to the thickness direction of the can lid cutter and the direction perpendicular to lids of cans.

### Outline of the Can Lid Cutter 100

A can lid cutter 100 is an instrument for cutting a lid from a can, and includes a main body 10, a blade 20, an operation portion 30, and a tab holder 40, as shown in FIG. 1. The detailed structure of each part will be described later.

A can 200 is a can containing a soft drink or an alcoholic drink, for example, and includes a can main body 201 and a lid 202 as shown in FIG. 10. The can main body 201 has a cylindrical shape, and the lid 202 is provided on an upper portion of the can main body 201. The lid 202 is disc-shaped and fixed to the can main body 201 via a cylindrical raised portion 205 formed on the upper portion of the can main body 201. A seam 205s is formed at an upper end portion of the raised portion 205. The seam 205s is an annular portion slightly projecting outward from the outer peripheral surface of the can main body 201 in the radial direction of the can 200.

The material of the can 200 from which the can lid cutter 100 can cut the lid 202 is not particularly limited, and the can 200 may be an aluminum can or a steel can. In addition, the size of the can 200 (particularly, the diameter of the lid 202) or the like is also optional.

A stay-on-tab 210 is provided on the upper surface of the lid 202 (see also FIG. 9). The stay-on-tab 210 is a member for opening a part of the lid 202, and is attached to the lid 202 by a fixing pin 220. The fixing pin 220 is positioned at the center of the lid 202, and the stay-on-tab 210 is rotatable about the fixing pin 220.

As shown in FIG. 9, the can lid cutter 100 rotates in the circumferential direction of the can 200 in a state where the main body 10 is mounted on the can 200, thereby cutting the inner periphery of the raised portion 205 of the can 200 with the blade 20 and cutting the lid 202 off from the can main body 201. According to the configuration of the present embodiment, a user can cut the lid 202 by a simple operation of rotating the can lid cutter 100 with respect to the can 200 while gripping the can lid cutter 100 with one hand, for example. In addition, since the stay-on-tab 210 is held by the tab holder 40, the lid 202 does not fall into the can 200 even after the lid 202 has been cut off.

### Configuration of Each Part

### (The Main Body 10)

As shown in FIGS. 1 and 2, the main body 10 has a top cover 10-1 and a bottom cover 10-2, and is an annular member in which an opening 10h is formed in its center. As shown in FIG. 3, the main body 10 has a contour that is close to an oval shape, with each rectangular corner formed in an arc shape. The opening 10h is circular, for example, and is specifically formed with a size such that a region near the central portion of the lid 202 is exposed in a state where the main body 10 is mounted on the can 200.

More specifically, the diameter of the opening 10h is 50% or more and 90% or less of the diameter of the lid 202 of the can 200. The opening 10h formed with such a size provides an advantage, allowing the user to easily check a cutting state of the lid 202 and a holding state of the stay-on-tab 210 through the opening 10h when the user uses the can lid cutter 100. It should be noted that the shape of the opening 10h is not limited to a circle, and may be a rectangle, an ellipse, or a polygon.

As shown in FIGS. 2 and 4, a circular recessed portion 11 formed in a circular shape for receiving the raised portion 205 of the can 200 is provided on the lower surface of the main body 10. The diameter of the circular recessed portion 11 is formed to be slightly larger than the diameter of the raised portion 205. As shown in FIG. 4, the circular recessed portion 11 is formed concentrically with the opening 10h of the main body 10, centered at a center point P.

As shown in FIG. 2, the circular recessed portion 11 is formed by an inner peripheral wall 11w and an upper surface 11u. The inner peripheral wall 11w is a cylindrical wall extending in the thickness direction of the main body 10. The inner peripheral wall 11w has a function of guiding the raised portion 205 of the can 200.

The upper surface 11u is an annular surface extending in a direction orthogonal to the thickness direction of the main body 10. A plurality of ribs 11u′ projecting from the upper surface 11u by a predetermined height are formed on the upper surface 11u. Each rib 11u′ is a structure portion that contacts the upper end of the raised portion 205 of the can 200 when the can lid cutter 100 has been mounted on the can 200.

As shown in FIG. 4, a pair of protrusions 13 projecting inward from the inner peripheral wall 11w in the radial direction of the circular recessed portion 11 is formed in the circular recessed portion 11. Each protrusion 13 is provided at a position that is on a center line Lx and symmetrical with respect to a center line Ly. Each protrusion 13 is a portion that elastically contacts a portion of the seam 205s of the raised portion 205 of the can 200 in a state where the main body 10 is mounted on the can 200. Each protrusion 13 has a hemispherical shape in the substantial radial direction, for example. The function of the protrusion 13 will be described later with reference to other drawings. It should be noted that although the pair of protrusions 13 is provided in the present embodiment, the number of protrusions 13 is arbitrary, and three or four or more protrusions 13 may be provided in the circular recessed portion 11, for example.

### (The Blade 20 and the Operation Portion 30)

As shown in FIGS. 2 and 4, the blade 20 is a circular rotary blade provided in the main body 10. Specifically, the blade 20 is attached to a part of the operation portion 30 by a fixing screw 21. The blade 20 rotates about the central axis of the fixing screw 21 extending in the thickness direction of the main body 10. A circular cutting edge that horizontally contacts the inner periphery of the raised portion 205 of the can 200 is formed on the outer periphery of the blade 20. As will be described later, the blade 20 is a replaceable component.

The operation portion 30 is a member for moving the blade 20, specifically, a member for moving the blade 20 toward the raised portion 205 in a state where the main body 10 is mounted on the can 200. As shown in FIGS. 5 and 6, the operation portion 30 includes a handle 31 and a main body member 32.

The handle 31 is a portion that is pushed toward the main body 10 by the user when the can lid cutter 100 is used. Specifically, as shown in FIG. 6, the handle 31 is formed to have a length that is slightly shorter than the longer side of the main body 10. Since the handle 31 is formed to have such a length, the user can firmly push the operation portion 30 toward the main body 10 with four fingers from the index finger to the little finger when the user grips the can lid cutter 100 with one hand, for example.

As will be described later, the handle 31 is a member for pressing the blade 20 toward the raised portion 205 through the principle of leverage, and the handle 31 formed with a longer length is advantageous in that the user can cut the raised portion 205 with a small force. The handle 31 is not necessarily formed to be shorter than the main body 10, and the handle 31 may be formed to be longer than the main body 10.

As shown in FIG. 7, the handle 31 is formed such that its length in the thickness direction of the main body 10 is shorter than the thickness of the main body 10. The handle 31 configured in this manner prevents the handle 31 from being bulky, and makes it possible to form the can lid cutter 100 compactly. It should be noted that such a configuration is not essential in the present disclosure, and the handle 31 may be equal to the thickness of the main body 10, or may be longer than the thickness of the main body 10.

As shown in FIG. 6, the main body member 32 is attached to the main body 10 in a manner to be pivotable about a shaft S1. The shaft S1 is a shaft extending in the thickness direction of the main body 10. In the main body member 32, a blade cover 32a in which the blade 20 is housed and a retainer for the blade 20 are formed at a position that is close to the shaft S1. As shown in FIG. 2, the blade cover 32a is formed in a substantially cylindrical shape and covers the periphery of the blade 20. Providing the blade cover 32a prevents the user's fingers from touching the blade 20.

The blade cover 32a does not cover the blade 20 on the lower surface of the blade 20. This allows the user to access the fixing screw 21 fixing the blade 20. The user can remove the blade 20 by removing the fixing screw 21 and replace the blade 20 as necessary.

As shown in FIG. 6, the main body member 32 has an arc-shaped elongated hole 35. The elongated hole 35 is formed in an end portion on the side of the main body member 32 that is away from the shaft S1. The elongated hole 35 is a structure portion for restricting the pivot range of the operation portion 30, and a boss B of the main body 10 passes through the elongated hole 35. The operation portion 30 pivots about the shaft S1 in any direction between a direction in which the boss B contacts one end 35a of the elongated hole 35 and a direction in which the boss B contacts the other end 35b of the elongated hole 35.

Due to the above-described configuration, the operation portion 30 is provided such that it moves in the substantially radial direction of the circular recessed portion 11 with respect to the main body 10. When the user moves the handle 31 of the operation portion 30 toward the main body 10, the entire operation portion 30 pivots about the shaft S1, and the blade 20 advances toward the outside of the circular recessed portion 11 such that it approaches the inner peripheral wall 11w.

The operation portion 30 is biased in a direction in which the operation portion 30 is separated from the main body 10 by a biasing means (not shown) such as a torsion spring or a leaf spring. The biasing means may be provided near the shaft S1. It should be noted that such a biasing means need not be provided in one embodiment of the present disclosure.

In the configuration in which the operation portion 30 is biased, by the biasing means, in a direction in which the operation portion 30 is separated from the main body 10, the operation portion 30 projects from the main body 10, and therefore the size of the can lid cutter 100 increases when stored. Here, in the configuration of the present embodiment, a protrusion 35t is formed in the elongated hole 35. The protrusion 35t is formed on the inner periphery of the elongated hole 35, and the width of the elongated hole 35 is partially narrowed at the portion where the protrusion 35t is formed. Specifically, the width of the elongated hole 35 is substantially the same as or slightly shorter than the diameter of the boss B.

In a state where the operation portion 30 is housed in the main body 10 (see FIG. 6), although force in a direction in which the operation portion 30 projects from the main body 10 due to the biasing force of the biasing means (not shown) is applied to the operation portion 30, the boss B cannot pass a portion of the protrusion 35t of the elongated hole 35, and thus the operation portion 30 does not open any farther. When the user pulls the operation portion 30 from the main body 10, the boss B passes a portion of the protrusion 35t, and therefore the operation portion 30 projects from the main body 10. Such a configuration prevents the operation portion 30 from projecting from the main body 10 when the can lid cutter 100 is not used, and makes it possible to store the can lid cutter 100 compactly.

As shown in FIG. 8, the operation portion 30 has a tool holder 37. The tool holder 37 is a structure portion that holds a tool T for removing the fixing screw 21 that fixes the blade 20 to the operation portion 30. The tool holder 37 may be provided at any position on the operation portion 30, but it is formed on the lower surface side of the operation portion 30 in the present embodiment. The tool holder 37 is a groove for receiving the tool T, and the tool T is a hexagonal wrench, for example. Depending on the shape of the head of the fixing screw 21, the tool holder 37 may hold other types of tools T such as a Phillips screwdriver, a slotted screwdriver, or a star-shaped screwdriver. According to the configuration of the present embodiment, since the operation portion 30 is provided with the tool T, the user can replace the blade 20 using the tool T.

### (The Tab Holder 40)

As shown in FIG. 9, the tab holder 40 is a member that holds the stay-on-tab 210 of the lid 202 in a state where the main body 10 is mounted on the can 200. As shown in FIG. 6, the tab holder 40 is provided inside the circular recessed portion 11 of the main body 10. The tab holder 40 is provided at a position on the side opposite the blade 20 across the center line Ly, for example.

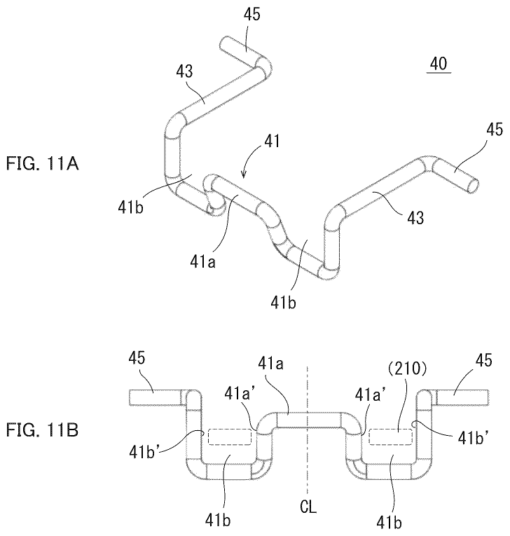

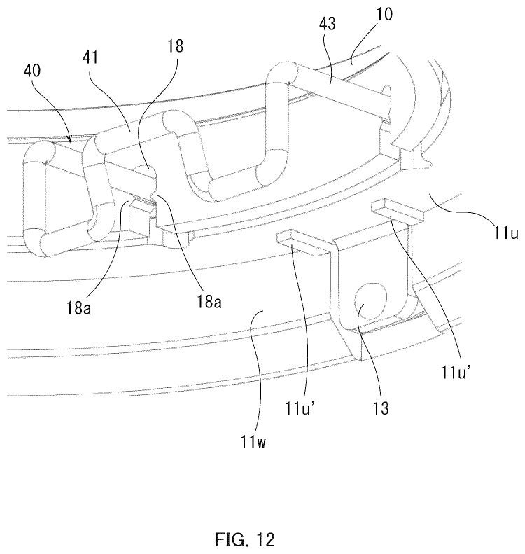

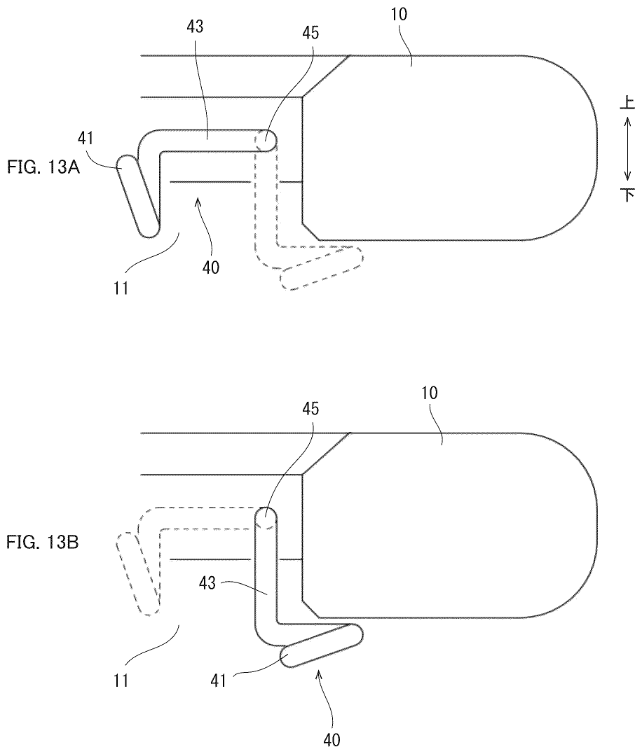

A detailed configuration of the tab holder 40 will be described with reference to FIGS. 11 to 14. FIG. 11A is a perspective view of the tab holder 40 and FIG. 11B is a front view of the tab holder 40. FIG. 12 is an enlarged perspective view of the tab holder 40 and its peripheral structure. FIGS. 13A and 13B are schematic views for explaining the movement of the tab holder 40.

As shown in FIGS. 11A and 11B, the tab holder 40 has a distal end portion 41, a connecting portion 43, and a rotation shaft portion 45. The tab holder 40 is a member that is formed by bending one wire, for example. The wire is made of metal, for example, and has a circular cross-sectional shape. A variation example of the tab holder 40 will be described later.

The distal end portion 41 includes a holding protrusion portion 41a to be inserted into an opening 210h of the stay-on-tab 210 (see FIG. 9), and a pair of tab holding recessed portions 41b formed on respective sides of the holding protrusion portion 41a. As shown in FIG. 11B, the distal end portion 41 is provided having a symmetrical shape with respect to a center line CL.

The holding protrusion portion 41a extends upward from the bottom of each tab holding recessed portion 41b. The holding protrusion portion 41a is formed to be slightly inclined so as to be easily inserted into the opening 210h of the stay-on-tab 210 when the can lid cutter 100 is used. Specifically, the holding protrusion portion 41a is inclined such that its distal end is closer to the center point P of the circular recessed portion 11 than its lower ends. The holding protrusion portion 41a may be provided such that an inclination angle with respect to the thickness direction of the can lid cutter 100 is in the range between 5° or more and 45° or less, for example.

As will be described later, the tab holder 40 is a member that holds the stay-on-tab 210 and rotates the stay-on-tab 210 around the fixing pin 220 when the can lid cutter 100 is used. As shown in FIG. 11B, side portions 41a′ on respective sides of the holding protrusion portion 41a are formed in a direction parallel to the thickness direction of the lid 202 (direction orthogonal to the width direction of the stay-on-tab 210) in a state where the can lid cutter 100 is mounted on the can 200 so that the stay-on-tab 210 is less likely to detach from the tab holder 40 during the rotation of the stay-on-tab 210.

The tab holding recessed portion 41b is a portion that receives the stay-on-tab 210. The tab holding recessed portion 41b is formed with a sufficient depth so that it can stably receive the stay-on-tab 210. In a similar manner as the holding protrusion portion 41a, a side portion 41b′ of the tab holding recessed portion 41b is also formed in a direction parallel to the thickness direction of the lid 202 (direction orthogonal to the width direction of the stay-on-tab 210) in a state where the can lid cutter 100 is mounted on the can 200 so that the stay-on-tab 210 is less likely to detach from the tab holder 40 during the rotation of the stay-on-tab 210.

Since the holding protrusion portion 41a and the tab holding recessed portion 41b are configured as described above, the stay-on-tab 210 is less likely to detach from the tab holder 40 when the user rotates the can lid cutter 100. Further, in the configuration of the present embodiment, the distal end portion 41 is formed symmetrically in the circumferential direction of the circular recessed portion 11 with respect to the center line CL. Therefore, even if the can lid cutter 100 is rotated either clockwise or counterclockwise with respect to the can 200, the tab holder 40 can hold the stay-on-tab 210 well.

In the present embodiment, the distal end portion 41 has the pair of tab holding recessed portions 41b, but the distal end portion 41 may have only the holding protrusion portion 41a.

As shown in FIG. 6, the connecting portion 43 extends toward the inside of the circular recessed portion 11 from the main body 10. The connecting portion 43 is a structure portion that connects the distal end portion 41 and the main body 10. In the present embodiment, the rotation shaft portion 45 is formed at an end of the connecting portion 43.

As shown in FIGS. 11A and 11B, the rotation shaft portion 45 is formed at an end of the connecting portion 43 on the side opposite to the distal end portion 41. The rotation shaft portion 45 is pivotally supported by the main body 10. Due to this, the tab holder 40 is configured to be able to pivot with respect to the main body 10.

As shown in FIG. 12, a groove 18 is formed in the main body 10 of the can lid cutter 100. The groove 18 is a groove for restricting the movable range of the tab holder 40. Specifically, the tab holder 40 is provided in a manner to be movable in (i) a direction in which the distal end portion 41 is positioned inside the circular recessed portion 11 and (ii) a direction in which the distal end portion 41 is further downward from the circular recessed portion 11.

The “direction in which the distal end portion 41 is positioned inside the circular recessed portion 11” is a direction in which the tab holder 40 extends in the horizontal direction (a first direction in which the holding protrusion portion of the distal end portion 41 holds the stay-on-tab 210) as shown in FIG. 12, FIG. 13A, and the like. As shown in FIG. 13B, the “direction in which the distal end portion 41 is further downward from the circular recessed portion 11” is a direction in which the connecting portion 43 extends downward from the main body 10 (a second direction in which the holding protrusion portion is further downward from the main body than the position of the holding protrusion portion in the first direction).

As shown in FIG. 12, a pair of protrusions 18a is formed in the groove 18. Each protrusion 18a is a structure portion for restricting the pivot of the tab holder 40. The width of the groove 18 is formed to be narrower than the thickness of the wire of the tab holder 40 at the portion where the protrusions 18a are formed. Such a configuration allows the can lid cutter 100 to hold the tab holder 40 in a direction in which the tab holder 40 extends in the horizontal direction. Meanwhile, the user pushing down the tab holder 40 with a finger can move the tab holder 40 from the orientation of FIG. 13A to the orientation of FIG. 13B, for example.

Instead of the pair of protrusions 18a, a single protrusion 18a may be formed. The shape of the protrusion 18a itself is not limited at all, and the protrusion 18a may be formed in any shape.

### (Explanation of the Operation)

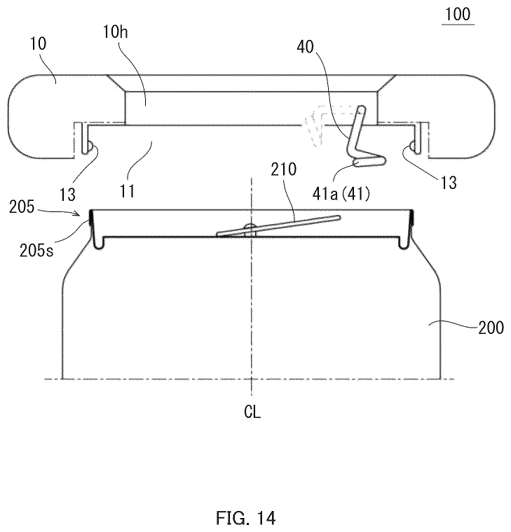

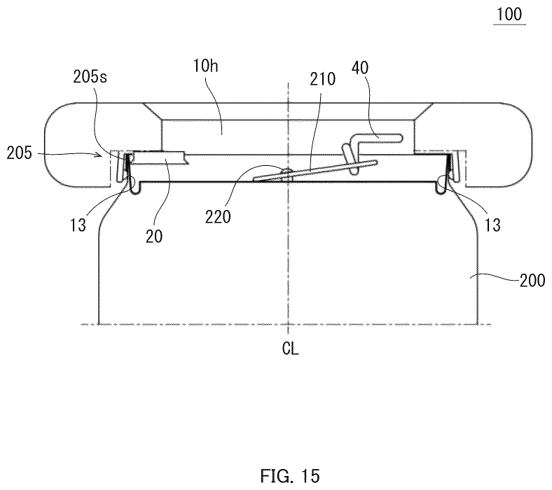

A method of using the can lid cutter 100 configured as described above will now be described. FIG. 14 is a view showing how the can lid cutter 100 is mounted on the can 200. FIG. 15 is a view showing the can lid cutter 100 mounted on the can 200. It should be noted that the order of the operations described below does not limit the present disclosure at all, and the order of the operations may be appropriately changed.

First, the user prepares the can lid cutter 100 and the can 200, and pulls the operation portion 30 from the main body 10 of the can lid cutter 100.

Next, as shown in FIG. 14, the user pushes down the tab holder 40 from the main body 10. This brings the tab holder 40 into a state where its distal end portion 41 is positioned below the main body 10.

Next, the user inserts the holding protrusion portion 41a of the distal end portion 41 of the tab holder 40 into the opening 210h of the stay-on-tab 210 from below the stay-on-tab 210. In the configuration of the present embodiment, since the holding protrusion portion 41a is formed to be slightly inclined, the user can easily insert the holding protrusion portion 41a into the opening 210h of the stay-on-tab 210.

The user then attaches the can lid cutter 100 to the can 200 such that the raised portion 205 of the can 200 is inserted into the circular recessed portion 11 of the main body 10. When the user attaches the can lid cutter 100 to the can 200, the pair of protrusions 13 in the circular recessed portion 11 elastically contacts the seam 205s of the raised portion 205. When the can lid cutter 100 is attached to a predetermined position, the pair of protrusions 13 climbs over the seam 205s and elastically contacts the outer peripheral surface of the can 200 below the seam 205s. A clicking feeling is exhibited when the pair of protrusions 13 climbs over the seam 205s.

According to the configuration in which the pair of protrusions 13 elastically contacts a portion of the seam 205s in this manner, the user can confirm that the can lid cutter 100 has been attached to the correct attachment position, through the feeling. In addition, the action of the protrusions 13 prevents the can lid cutter 100 from detaching from the can 200, so that the position of the can lid cutter 100 is maintained at a desired attachment position.

In a state where the can lid cutter 100 is attached to the can 200, the cutting edge of the blade 20 has not yet contacted the inner periphery of the raised portion 205. Next, the user moves the operation portion 30 toward the main body 10. For example, the user grips the can lid cutter 100 with one hand and moves the operation portion 30 toward the main body 10. As a result, the entire operation portion 30 pivots around the shaft S1 (see FIG. 6), and the cutting edge of the blade 20 is pressed against the inner periphery of the raised portion 205.

According to the can lid cutter 100 of the present embodiment, as shown in FIG. 6, the handle 31 of the operation portion 30 is formed to be relatively long along the main body 10, but the blade 20 is provided at a position that is relatively close to the shaft S1. Specifically, the operation portion 30 is formed such that the distance from the center of the shaft S1 to a portion of the handle 31 on the side that is away from the shaft S1 (a portion serving as one of the points of effort when the can lid cutter 100 is used) is longer than the distance from the center of the shaft S1 to the center of the blade 20. The operation portion 30 formed in such a shape allows the user to press the blade 20 against the raised portion 205 with force that is greater than the force applied to the handle 31, which is the point of effort, through the principle of leverage.

Next, the user rotates the can lid cutter 100 with respect to the can 200 while pushing the operation portion 30 toward the main body 10 in a state where the can lid cutter 100 is mounted on the can 200. When the can lid cutter 100 is rotated with respect to the can 200, the cutting edge of the blade 20 rolls against the inner periphery of the raised portion 205 while being pressed thereagainst, so that the inner periphery of the raised portion 205 is gradually cut.

While the can lid cutter 100 is rotating, the stay-on-tab 210 held by the tab holder 40 rotates about the fixing pin 220.

In the can lid cutter 100 of the present embodiment, the can lid cutter 100 rotates in a state where the rib 11u′ in the circular recessed portion 11 contacts the upper end of the raised portion 205 of the can 200. According to such a configuration, the contact area between the rib 11u′ and the raised portion 205 becomes small, which allows the user to easily rotate the can lid cutter 100. In addition, in a case of the configuration in which the rib 11u′ contacts the raised portion 205, there is an advantage in that dimensional accuracy of components during manufacturing and positional accuracy during installation can be easily increased.

The lid 202 is cut off from the can 200 by rotating the can lid cutter 100 once or more than once until the inner periphery of the raised portion 205 has been cut over the entire circumference. After the lid 202 has been cut off, the user lifts the can lid cutter 100 up off the can 200. Due to this, the lid 202 has been cut, causing the can 200 to enter the state where its upper portion is opened. It should be noted that, when the user lifts the can lid cutter 100 up off the can 200, the tab holder 40 may pivot downward from the horizontal direction, or the tab holder 40 may maintain the horizontal direction.

### (Operation Effects of the Can Lid Cutter 100)

As described above, according to the configuration of the present embodiment, the user can cut the lid 202 from the can 200 by simple operations of mounting the can lid cutter 100 on the can 200 and rotating the can lid cutter 100 while pushing the operation portion 30 toward the main body 10. In addition, since the lid 202 that has been cut off is held by the tab holder 40, which prevents the lid 202 from falling into the can 200.

Further, since the tab holder 40 is configured to be pivotable with respect to the main body 10, the user can easily insert the holding protrusion portion 41a of the tab holder 40 into the opening 210h of the stay-on-tab 210 when the user mounts the can lid cutter 100 on the can 200.

Further, since the tab holder 40 has not only the holding protrusion portion 41a but also the pair of tab holding recessed portions 41b for receiving the stay-on-tab 210 on respective sides of the holding protrusion portion 41a, the tab holder 40 can hold the stay-on-tab 210 more stably.

In addition, since the opening 10h is formed in the main body 10, the user can check a cutting state of the lid 202 and the like through the opening 10h when using the can lid cutter 100.

In addition, since a plurality of protrusions 13 formed inside the circular recessed portion 11 elastically contacts the seam 205s of the raised portion 205 when the can lid cutter 100 is mounted, the user can confirm whether the can lid cutter 100 is properly mounted on the can 200, which reduces an occurrence of cutting errors of the lid.

In the can lid cutter 100 of the present embodiment, the inner periphery of the raised portion 205 of the can 200 is cut by the blade 20, and the outer periphery of the raised portion 205 remains. Therefore, the portion from which the lid has been cut does not touch the mouth of the user, allowing the user to drink safely.

### Variation Example 1

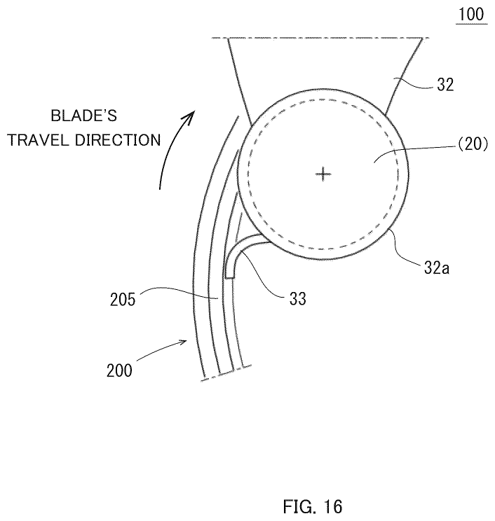

Although the can lid cutter 100 according to one embodiment of the present disclosure has been described above with reference to the drawings, the present disclosure is not limited to the specific structure described above. FIG. 16 shows a variation example of the can lid cutter of the present disclosure. FIG. 16 is a schematic top view of the blade 20 and a blade cover 32a of the can lid cutter.

### (The Cleaning Member)

The can lid cutter 100 of FIG. 16 has a cleaning member 33. The cleaning member 33 is a member for cleaning by sweeping chips of a cut portion of the inner periphery of the raised portion 205 when the can lid cutter 100 cuts the raised portion 205. The cleaning member 33 may be a brush-like member that contacts the raised portion 205, or may be an elastic member that contacts the raised portion 205. The cleaning member 33 may be made of rubber, for example.

The cleaning member 33 may be attached to any position on the can lid cutter 100, as long as the cleaning member 33 contacts the cut portion of the raised portion 205. In the example of FIG. 16, the cleaning member 33 is attached to the blade cover 32a. The cleaning member 33 may be provided in a manner to be replaceable, for example.

In addition to the above, the main body 10 need not have the opening 10h, for example. The blade 20 may cut the outer periphery of the raised portion 205 of the can 200. In the operation portion 30, the protrusion 35t need not be formed in the elongated hole 35.

The tab holder 40 need not pivot with respect to the main body 10. The shape of the tab holder 40 can be appropriately changed, and may be the shape obtained by simply bending a plate material, for example. Specifically, the tab holder may be a member having (i) a connecting portion extending toward the center from the inside of the circular recessed portion 11 and (ii) a holding protrusion portion that is positioned at a distal end portion of the connecting portion and to be inserted into the opening 210h of the stay-on-tab 210.

The tab holder 40 need not hold the opening 210h of the stay-on-tab 210, but may be configured to hold another portion. For example, in the case of the stay-on-tab 210 in which the opening 210h is not formed, a part of the tab holder 40 may be inserted into an opening of the stay-on-tab 210, which is positioned near the fixing pin 220, as an example. The material of the tab holder 40 is arbitrary, and may be resin, for example, and is not limited to metal. The tab holder 40 may be a member in which a part of it is formed of metal and the other part of it is formed of resin.

### (Another Configuration Example of the Tab Holder and the Circular Recessed Portion)

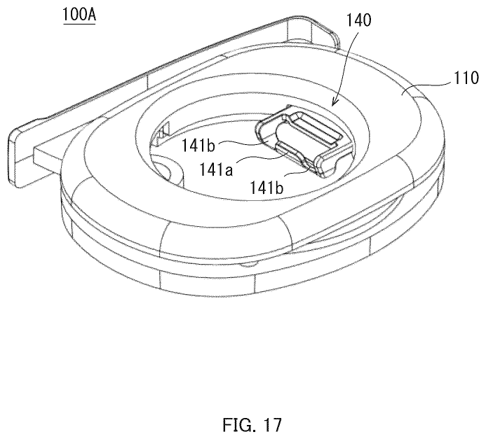

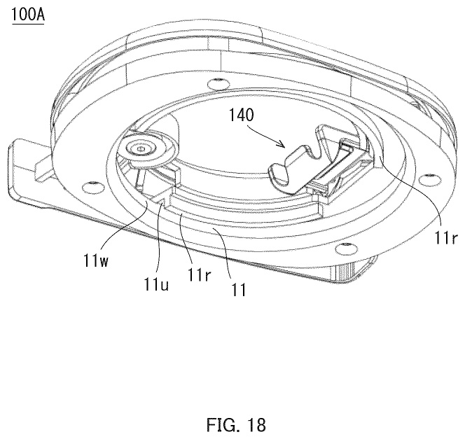

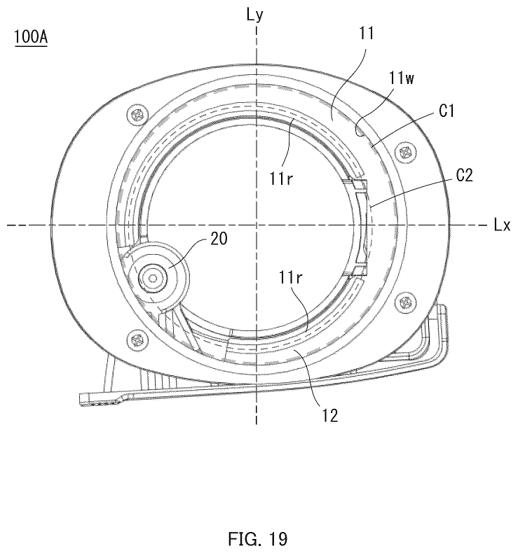

Next, another configuration example of the can lid cutter will be described with reference to FIGS. 17 to 19. FIG. 17 is a perspective view showing another configuration example of the can lid cutter. FIG. 18 is a perspective bottom view of a can lid cutter 100A of FIG. 17. FIG. 19 is a bottom view of the can lid cutter 100A of FIG. 17. It should be noted that the tab holder is omitted in FIG. 19.

The can lid cutter 100A differs from the can lid cutter 100 of the above-described embodiment in the following points. Specifically, the can lid cutter 100A has a main body 110 and a tab holder 140 having shapes that are different from those of the main body 10 and the tab holder 40 of the can lid cutter 100. Also, with respect to the structure of the circular recessed portion 11 inside the main body 110, the can lid cutter 100A has a structure that is different from that of the can lid cutter 100.

The main body 110 of the can lid cutter 100A is formed with a slightly rounder contour than the main body 10 in the above-described embodiment (see FIG. 19), although this is not an essential difference.

The tab holder 140 is a member made of resin or metal, for example, and has a holding protrusion portion 141a and a tab holding recessed portion 141b as shown in FIG. 17. The tab holder 140 is configured to be pivotable in the horizontal direction as shown in FIG. 17 and in a downward direction (not shown) with respect to the main body 110, in a similar manner as in the above-described embodiment.

As shown in FIGS. 18 and 19, an arc-shaped rib 11r projecting downward from the upper surface 11u is formed in the circular recessed portion 11 of the main body 110. In this example, as shown in FIG. 19, the rib 11r is formed such that it extends along a reference circle C2 that is slightly smaller than a reference circle C1 along the inner peripheral wall 11w of the circular recessed portion 11. The rib 11r is a structure portion serving as a guide when other types of cans having smaller diameters than the can 200 (FIG. 15) are cut.

In a case where a can lid having a raised portion with a smaller diameter than the raised portion 205 of the can 200 is to be cut with the can lid cutter 100 of the above-described embodiment, it is difficult to guide the raised portion well on the inner peripheral surface of the circular recessed portion 11 due to the raised portion having a small diameter. As a result, the lid may not be cut successfully. Therefore, in the configuration of FIGS. 17 to 19, a ring-shaped guide recessed portion 12 is formed between the rib 11r and the inner peripheral wall 11w in the circular recessed portion 11, so that raised portions of cans with different sizes can be received by the guide recessed portion 12.

The can lid cutter 100A cuts the raised portion of the can by sandwiching the raised portion between the inner peripheral wall 11w and the blade 20, and the positions of the reference circle C1 and the reference circle C2 are set on the basis of the position where the blade 20 contacts the inner peripheral wall 11w. Therefore, the reference circle C1 and the reference circle C2 are not concentric, and the reference circle C2 is slightly eccentric to the blade 20.

According to the can lid cutter 100A having the above-described configuration, it is possible to cut the lid well using the can lid cutter 100A for a plurality of types of cans having different lid sizes.

### Variation Example 2

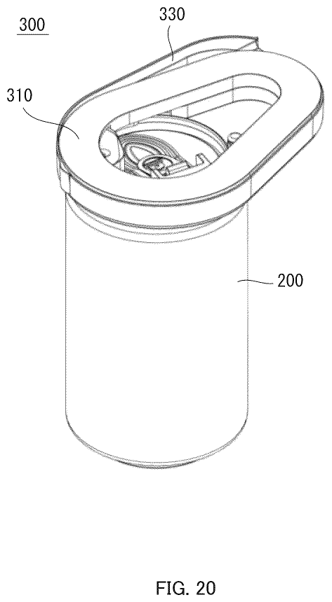

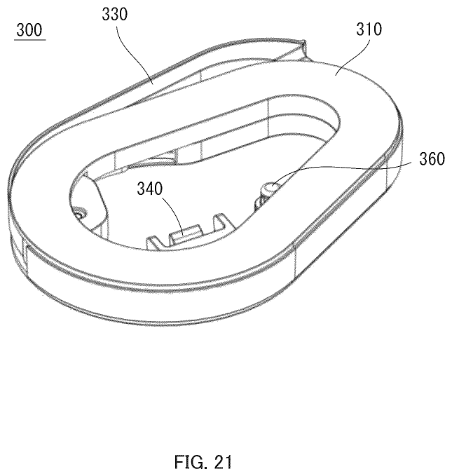

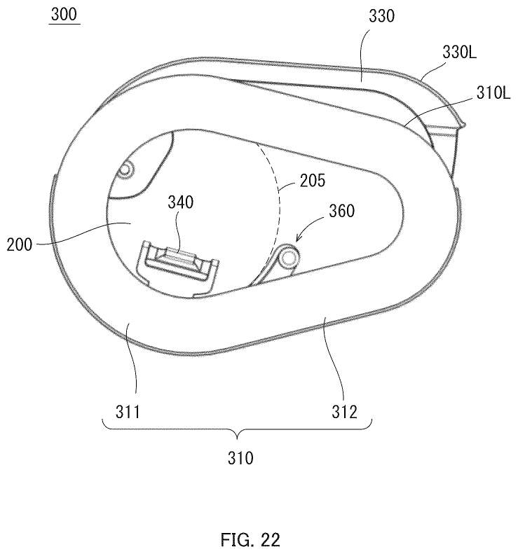

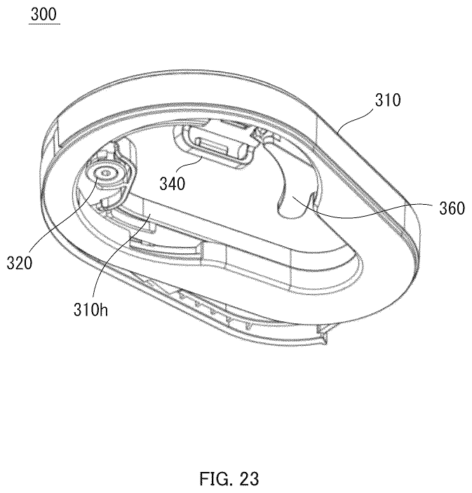

The can lid cutter of the present disclosure may be as shown in FIGS. 20 to 24. FIG. 20 is a perspective view showing a can lid cutter 300 of one embodiment of the present disclosure mounted on the can 200. FIG. 21 is a perspective top view of the can lid cutter 300. FIG. 22 is a planar view of the can lid cutter 300. FIG. 23 is a perspective bottom view of the can lid cutter 300.

In the following description, each part of the can lid cutter 300 is indicated by the reference numerals in the 300 series. The last two digits of the reference numerals correspond in principle to the reference numerals of the above-described embodiments, and redundant description will be omitted.

Although this can lid cutter 300 is similar as the above-described embodiments in the principle of cutting the raised portion 205 by bringing a blade 320 into contact with the raised portion 205 of the can 200, the can lid cutter 300 includes a main body 310 and an operation portion 330 having shapes that are different from those of the above-described embodiments, as an example. One of the features of the can lid cutter 300 is that a sliding member is disposed near the blade 320 and that it has an adapter member that holds the raised portion 205 of the can 200, as will be described in detail later. It is not essential to provide both of the sliding member and the adapter member, and only one of them need be provided.

As shown in FIGS. 20 to 23, the main body 310 is formed in a slightly elongated annular shape. Specifically, in this example, the main body 310 is formed in an annular shape such that an arc, which is a part of a large circle (not shown), and an arc, which is a part of a small circle (not shown), are connected to each other by two straight lines. More specifically, as shown in FIG. 22, the main body 310 includes a guide region 311 and an extension region 312.

The guide region 311 is an arc-shaped region along a part of the outer periphery of the raised portion 205 of the can 200. The extension region 312 is a region formed such that it extends in a direction away from the raised portion 205. The extension region 312 is formed integrally with the guide region 311 in a manner to be continuous with the guide region 311.

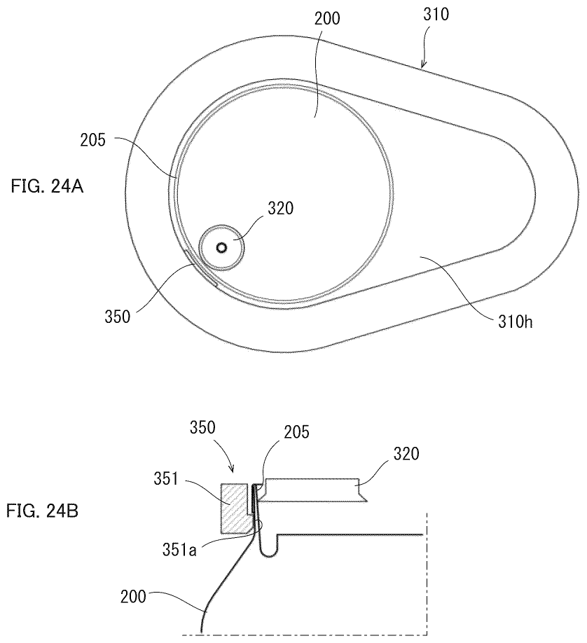

The operation portion 330 is disposed such that it extends in a direction that is substantially the same as the direction in which the extension region 312 extends. In a similar manner as in the above-described embodiments, the operation portion 330 is pushed toward the main body 310 by the user. In this example, the operation portion 330 may have a shape such that substantially the entire operation portion 330 enters the inside of the main body 310. Specifically, when the operation portion 330 is housed, the operation portion 330 may be configured such that its side surface 330L (FIG. 22) is positioned at substantially the same position as a side surface 310L (contour line) of the main body 310, for example. According to such a configuration, since the outer shape of the can lid cutter 300 at the time when the operation portion is housed is a shape like that of the main body 310 that is schematically illustrated in FIG. 24A, the can lid cutter is not bulky, resulting in an improved design.

For example, force may be applied to the operation portion 330 in a direction away from the main body 310 by a member such as a leaf spring or a torsion spring.

As shown in FIG. 23, a recessed portion 310h is formed in the main body 310. In a similar manner as in the above-described embodiments, the recessed portion 310h is provided with the blade 320 and a tab holder 340. The recessed portion 310h is also provided with an adapter member 360. Details of the adapter member 360 will be described below with reference to other figures.

### (The Sliding Member)

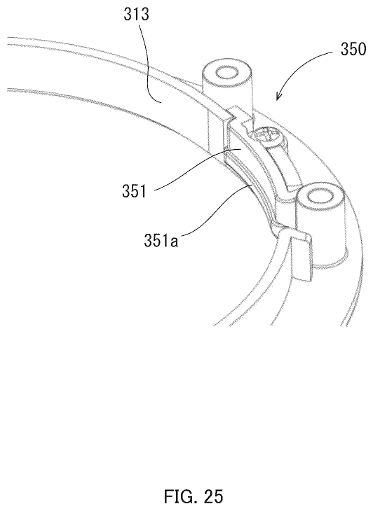

FIGS. 24A and 24 B are views for explaining a sliding member 350. FIG. 24A schematically shows the main body 310, the blade 320, and the sliding member 350, and FIG. 24B schematically shows a cross section of the blade 320 and the sliding member 350. FIG. 25 is a perspective view showing the sliding member 350 and its peripheral structure.

The can lid cutter 300 may have the sliding member 350 in order for the blade 20 to smoothly cut the raised portion 205. The sliding member 350 is provided in the recessed portion 310h. Specifically, as shown in FIGS. 24A and 24B, the sliding member 350 is provided at a position such that it holds the outer peripheral surface of the raised portion 205 in a state where the main body 310 is mounted on the can 200. More specifically, the sliding member 350 is located at a position on the side opposite of the blade 320 relative to the raised portion 205.

As shown in FIG. 25, the sliding member 350 has a curved, arc-shaped portion. The sliding member 350 contacts the outer periphery of the raised portion 205 when the blade 320 is pressed against the raised portion 205. The sliding member 350 is formed of a material having higher slidability than the other components constituting the main body 310. The sliding member 350 may be resin such as polyamide (PA) or polyacetal (POM), for example. As shown in FIG. 24B, the sliding member 350 has a cross-sectional shape including a main body 351 and a projection portion 35la projecting radially inward from the main body 351.

The projection portion 35la projects beyond the inner peripheral surface 313 (FIG. 25) of the main body 310, and comes into contact with a portion below the seam 205s (FIG. 15) of the raised portion 205. According to such a configuration, when the blade 320 cuts the raised portion 205, the projection 351a engaging the portion below the seam 205s makes it possible to prevent the can lid cutter 300 from lifting up and maintain the blade 320 at a good position when the raised portion 205 is cut. In addition, since the outer peripheral surface of the raised portion 205 is held by the sliding member 350 when the raised portion 205 is cut, it is possible to cut the raised portion 205 stably.

### (The Adapter Member)

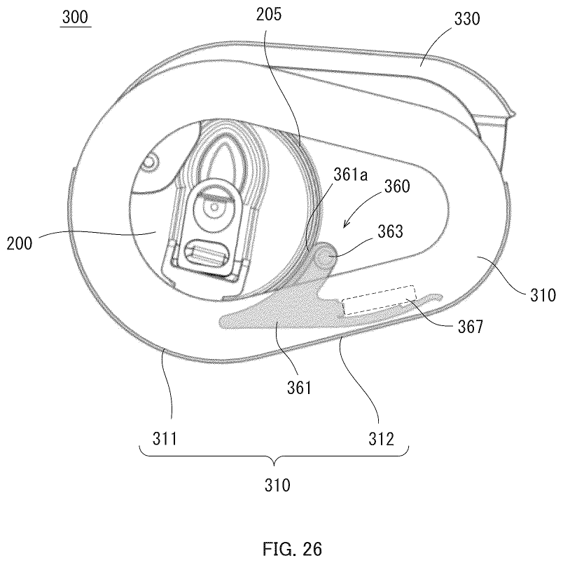

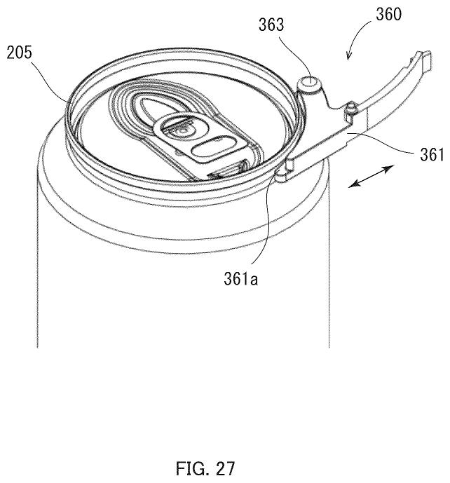

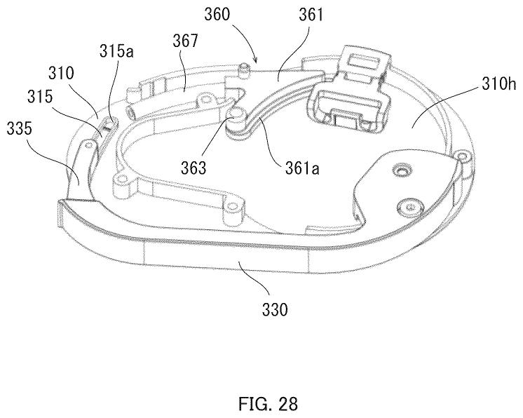

The can lid cutter 300 according to one embodiment of the present disclosure may have the adapter member 360 as shown in FIGS. 26 to 28. FIG. 26 is a top view of the can lid cutter 300. FIG. 27 is a perspective view showing the adapter member 360 holding the raised portion 205 of the can 200. FIG. 28 shows the adapter member 360 provided in the main body 310. FIG. 28 shows the adapter member 360 with a part of the main body 310 omitted when viewed from the top.

The adapter member 360 is a member that holds the outer peripheral surface of the raised portion 205 of the can 200. As shown in FIG. 26, the adapter member 360 is provided in the main body 310, and is configured to be movable in a manner to advance and retreat with respect to the outer peripheral surface of the raised portion 205.

As shown in FIG. 27, the adapter member 360 has a main body 361, a guide portion 361a, and a lever portion 363. The guide portion 361a is formed in an arc shape corresponding to the shape of the outer peripheral surface of the raised portion 205 of the can 200. Specifically, as understood from FIG. 26, the guide portion 361a holds the outer peripheral surface of the raised portion 205 that is not guided by the guide region 311. The guide portion 361a may contact the seam of the raised portion 205, but in this example, the guide portion 361a contacts a region below the seam of the raised portion 205. Such a configuration makes it possible to prevent the can lid cutter 300 from lifting up during use and cut the raised portion 205 well.

As shown in FIG. 28, an elastic member 367 is disposed in the vicinity of the adapter member 360. The elastic member 367 is a member that applies force in a direction in which the adapter member 360 is pressed toward the outer peripheral surface of the raised portion 205 of the can 200. The elastic member 367 may be a coil spring or a rubber tube, for example. The elastic member 367 is disposed in a compressed state in FIG. 28, so that the elastic member 367 biases the adapter member 360 substantially toward the center of the recessed portion 310h.

The lever portion 363 is a protrusive portion operated by the user. As shown in FIG. 26, the lever portion 363 is disposed inside the extension region 312 of the main body 310, as an example. In this example, the lever portion 363 is provided on the side that is away from the operation portion 330 (the lower side of FIG. 26). Such a configuration allows the user to grip the operation portion 330 with four fingers from the index finger to the little finger and operate the lever portion 363 with the thumb, for example.

The user pushes the lever portion 363 in a direction in which the adapter member 360 is separated from the can 200, thereby separating the entire adapter member 360 from the raised portion 205. The user attaches the can lid cutter 300 to the can 200 in this state. The user releases their fingers from the lever portion 363, thereby causing the adaptor member 360 to be pressed toward the raised portion 205 with the elastic member 367, and thus the guide portion 361a holds the raised portion 205. Such a configuration realizes the stable attachment of the can lid cutter 300.

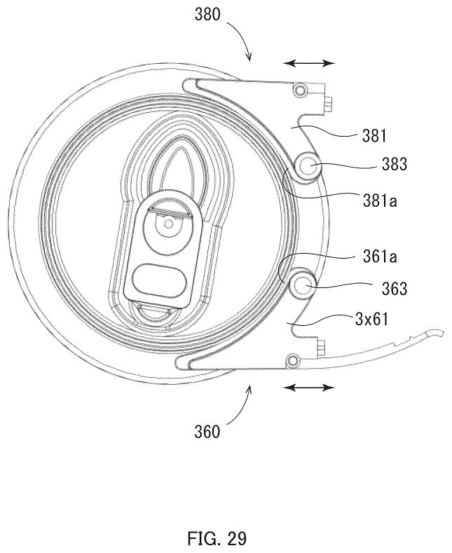

FIG. 29 is a view for explaining a further variation example of the can lid cutter. The can lid cutter of one embodiment of the present disclosure may have an adapter member 380 on the side opposite to the adapter member 360 illustrated in FIG. 6 (that is, the operation portion 330 side). Although the adapter member 360 and the adapter member 380 are shown in the configuration of FIG. 29, only the adapter member 380 need be provided.

In this example, in a similar manner as the adapter member 360, the adapter member 380 has a main body 381, a guide portion 381a, and a lever portion 383. The adapter member 380 may be provided in the main body 310 or may be provided in the operation portion 330. As an example, the adapter member 380 may be configured to be pressed toward the raised portion 205 by an elastic member (not shown) in a similar manner as the adapter member 360.

Instead of using the elastic member, the adapter member 380 may be configured such that the adapter member 380 is pressed against the raised portion 205 in conjunction with an operation of closing the operation portion 330.

It should be noted that a leaf spring, a coil spring, or the like may be provided between the operation portion 330 and the main body 310, and force in a direction to open the operation portion 330 may be applied to the operation portion 330 by receiving force from these springs. In such a configuration, a means for positioning the operation portion 330 in the closed position may be provided, although this is not limited to such.

Specifically, the following configuration may be employed. For example, as shown in FIG. 28, a protrusion (not shown) that moves along a guide groove 315 of the main body 310 is provided at an end portion 335 of the operation portion 330. When the operation portion 330 moves to the closed position, the protrusion moves along a portion of the guide groove 315. Further, the protrusion fits into an engagement recessed portion 315a formed in a part of the guide groove 315, thereby positioning the operation portion 330 in a predetermined closed position. The operation portion 330 may be configured to exhibit a clicking feeling when the protrusion fits into the engagement recessed portion 315a, so that the user can confirm that the operation portion 330 has been securely placed in the predetermined closed position.

The present disclosure is explained on the basis of the exemplary embodiments. The technical scope of the present disclosure is not limited to the scope explained in the above embodiments and it is possible to make various changes and modifications within the scope of the invention. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A can lid cutter that cuts a lid from a can by cutting a cylindrical raised portion of an outer periphery at an upper end of the can, the can lid cutter comprising:
a main body having a recessed portion receiving the raised portion;
a blade for cutting an inner periphery of the raised portion;
an operation portion for pressing the blade toward the raised portion in a state where the main body is mounted on the can; and
a tab holder that holds a stay-on-tab of the lid while the can lid cutter is rotating with respect to the can in a state where the main body is mounted on the can.

2. The can lid cutter according to claim 1, wherein
the main body has an opening that exposes a center of the lid and a region near a central portion of the lid in a state where the main body is mounted on the can.

3. The can lid cutter according to claim 2, wherein
the opening is larger than the stay-on-tab.

4. The can lid cutter according to claim 2, wherein
the opening has a size such that the entire stay-on-tab is exposed.

5. The can lid cutter according to claim 2, wherein
an inner length of the opening includes a portion that is 50% or more of a diameter of the lid.

6. The can lid cutter according to claim 1, wherein
the tab holder has:
a holding protrusion portion that is inserted into an opening of the stay-on-tab and holds the stay-on-tab, and
a connecting portion that extends toward the inside of the recessed portion from the main body and connects the holding protrusion portion and the main body, wherein
the tab holder is configured such that the stay-on-tab held by the tab holder rotates, together with the main body, about a fixing pin fixing the stay-on-tab to the lid, due to the main body rotating in a circumferential direction of the can in a state where the main body is mounted on the can, and
the tab holder is configured to be movable in (i) a first direction in which the holding protrusion portion holds the stay-on-tab and (ii) a second direction in which the holding protrusion portion is further downward from the main body than a position of the holding protrusion portion in the first direction, due to the connecting portion pivotally supported by the main body.

7. The can lid cutter according to claim 1, wherein
the tab holder has:
a holding protrusion portion that is inserted into an opening of the stay-on-tab and holds the stay-on-tab, and
a connecting portion that extends toward the inside of the recessed portion from the main body and connects the holding protrusion portion and the main body, wherein
the tab holder is configured such that the stay-on-tab held by the tab holder rotates, together with the main body, about a fixing pin fixing the stay-on-tab to the lid, due to the main body rotating in a circumferential direction of the can in a state where the main body is mounted on the can, and
the tab holder has a pair of tab holding recessed portions receiving the stay-on-tab, on respective sides of the holding protrusion portion in the circumferential direction.

8. The can lid cutter according to claim 1, wherein
the blade cuts an inner periphery of the raised portion,
the operation portion is provided such that the operation portion moves in a direction in which the operation portion approaches the recessed portion and in a direction in which the operation portion is separated from the recessed portion with respect to the main body, and the operation portion is configured such that the blade advances towards the outside of the recessed portion when the operation portion moves toward the main body, and
the main body has a sliding portion that is located at a position on the opposite side of the blade relative to the raised portion and holds an outer peripheral surface of the raised portion, in a state where the main body is mounted on the can.

9. The can lid cutter according to claim 8, wherein
a cross-sectional shape of the sliding portion includes a projection portion that contacts a portion below a seam of the raised portion when the blade is pressed against the raised portion.

10. The can lid cutter according to claim 1, wherein
the main body has a protrusion that elastically contacts a portion of a seam of the raised portion of the can in a state where the main body is mounted on the can.

11. The can lid cutter according to claim 1, wherein
the main body has a cleaning member cleaning a cut portion, formed on the raised portion by the blade, by contacting the cut portion.

12. The can lid cutter according to claim 1, wherein
the main body has a shape having an opening that exposes a center of the lid and a region near a central portion of the lid in a state where the main body is mounted on the can, and
the main body has a shape including:
a guide region formed in an arc shape along a part of an outer periphery of the raised portion, and
an extension region formed in a manner to be continuous with the guide region and formed such that the extension region extends in a direction away from the raised portion.

13. The can lid cutter according to claim 1, further comprising:
an adapter member that is configured to be movable in a manner to advance and retreat with respect to an outer peripheral surface of the raised portion, and holds the outer peripheral surface by advancing toward the outer peripheral surface.

14. The can lid cutter according to claim 13, wherein
the adapter member includes a lever portion operated by a user to move the adapter member.

15. The can lid cutter according to claim 1, wherein
the main body has an opening through which a user can check a cutting state of the lid and a holding state of the stay-on-tab in a state where the main body is mounted on the can.

16. The can lid cutter according to claim 1, wherein
the main body has an opening, and
the opening exposes (i) a center of the lid where a fixing pin fixing the stay-on-tab to the lid is positioned and (ii) a region near a central portion of the lid where the stay-on-tab attached to the lid by the fixing pin is positioned.

17. The can lid cutter according to claim 16, wherein
the recess of the main body receives the entire raised portion.
